(19) United States
(12) Patent Application Publication
(10) Pub. No.: US 2024/0399810 A1
(43) Pub. Date: Dec. 5, 2024

(54) SHOCK ABSORBER

(71) Applicant: KYB Corporation, Tokyo (JP)

(72) Inventors: Yoshiki MATSUOKA, Tokyo (JP); Kyusuke TSUCHIDA, Tokyo (JP)

(73) Assignee: KYB Corporation, Tokyo (JP)

(21) Appl. No.: 18/698,025

(22) PCT Filed: Nov. 22, 2022
(86) PCT No.: PCT/JP2022/043111

§ 371 Date: Apr. 3, 2024

(30) Foreign Application Priority Data
Dec. 20, 2021 (JP) 2021-206238

(51) Int. Cl. B60G 13/18; B60G 13/08

(52) U.S. Cl. CPC B60G 13/18; B60G 13/08

(57) ABSTRACT

A shock absorber according to the present embodiment includes a shock absorber main body having a cylindrical outer shell and a rod movably inserted into the outer shell, and a knuckle bracket attached to an outer periphery of a lower end of the outer shell, in which the knuckle bracket includes a pair of clamping pieces that are curved along an outer periphery of the outer shell and clamp the outer shell, a pair of attachment pieces that extend in a radial direction of the outer shell from the ends in a circumferential direction of the respective clamping pieces and face each other, and a connecting piece that connects ends of the attachment pieces, a width between the tip ends in the circumferential direction of the inner peripheral surfaces of the respective clamping pieces is larger than the outer diameter of the outer shell, and the proximal end side than the tip ends in the circumferential direction of the inner peripheral surfaces of the respective clamping pieces abuts on the outer periphery of the outer shell.

### TECHNICAL FIELD

The present invention relates to a shock absorber.

### BACKGROUND ART

A shock absorber includes an outer shell and a rod that is movably inserted into the outer shell, and is used by being incorporated in a suspension in a vehicle, for example, to suppress the vibration of the vehicle body and the wheel. As the piston rod moves in the axial directions with respect to the outer shell, the shock absorber becomes extended and contracted, and exerts a damping force thereby.

When such a shock absorber incorporated in a suspension is used in a strut suspension, for example, a knuckle bracket, which is for attaching a knuckle for holding a wheel of a vehicle, is attached, by welding, to the bottom end of the outer shell.

As disclosed in, for example, JP 2002-130360 A, a knuckle bracket includes a pair of curved tube abutting portions that abut on an outer periphery of an outer shell, a pair of knuckle attachment portions that extend parallel to each other in a radial direction of the outer shell from ends in a circumferential direction of the tube abutting portions and can be connected to the knuckle, and a connecting portion that connects upper ends of the respective attachment portions (see, for example, FIG. 6 of Patent Literature 1).

### CITATION LIST

### Patent Literature

Patent Literature 1: JP 2002-130360 A

### SUMMARY OF INVENTION

### Technical Problem

In the shock absorber configured as described above, the inner peripheral surface of the tube abutting portion of the knuckle bracket abutting on the outer shell and the side surface of the connecting portion abutting on the outer shell are curved surfaces having the same curvature as the curvature of the outer diameter of the outer shell to be along the outer periphery of the outer shell.

Therefore, when the outer shell and the knuckle bracket are molded according to design dimensions, the inner peripheral surface of the tube abutting portion and the side surface of the connecting portion closely abut on the outer periphery of the outer shell, the periphery of the tube abutting portion and the connecting portion is welded to the outer shell except for the lower end of the tube abutting portion, and the knuckle bracket is fixed to the outer shell.

However, in practice, since there is a dimensional tolerance between the dimensions of the knuckle bracket and the dimensions of the outer shell, there is a problem that the abutment situation between the knuckle bracket and the outer shell changes for each product, the knuckle bracket and the outer shell do not abut on each other tightly, backlash occurs between the knuckle bracket and the outer shell, and the welding quality of the knuckle bracket and the outer shell is different for each product and is not stable.

Therefore, an object of the present invention is to provide a shock absorber capable of improving and stabilizing welding quality at a welded portion between an outer shell and a knuckle bracket.

### Solution to Problem

In order to solve the problems, a shock absorber of the present invention includes a shock absorber main body having a cylindrical outer shell and a rod movably inserted into the outer shell, and a knuckle bracket attached to an outer periphery of a lower end of the outer shell, in which the knuckle bracket includes a pair of clamping pieces that are curved along an outer periphery of the outer shell and clamp the outer shell, a pair of attachment pieces that extend in a radial direction of the outer shell from ends in a circumferential direction of the respective clamping pieces and face each other, and a connecting piece that connects ends of the attachment pieces, and a proximal end side than a tip end in a circumferential direction of an inner peripheral surface of each of the clamping pieces abuts on the outer periphery of the outer shell.

In the shock absorber configured as described above, when the outer shell is inserted between the clamping pieces from the side, the outer shell enters between the clamping pieces without being abutted by the proximal end side of the clamping piece in the circumferential direction, and is stably supported by being in contact with two portions on the tip end side excluding the tip end in the circumferential direction of the inner peripheral surface of the clamping piece, and an excessively large gap is not generated between the inner peripheral surface of the clamping piece and the side surface of the connecting piece and the outer shell.

### BRIEF DESCRIPTION OF DRAWINGS

FIG. 1 is a side view of a shock absorber according to an embodiment.

FIG. 2 is a front view of a knuckle bracket in the shock absorber according to the embodiment.

FIG. 3 is a side view of the knuckle bracket of the shock absorber according to the embodiment.

FIG. 4 is a plan view of the knuckle bracket of the shock absorber according to the embodiment.

FIG. 5 is a plan view of the knuckle bracket attached to the shock absorber according to the embodiment.

FIG. 6(a) illustrates a flat plate punched into a shape in which the knuckle bracket is developed. FIG. 6(b) illustrates a semi-finished product of a knuckle bracket in which a clamping piece and an attachment piece are molded.

FIG. 6(c) illustrates a semi-finished product of a knuckle bracket after a bolt insertion hole is formed in the attachment piece.

### DESCRIPTION OF EMBODIMENTS

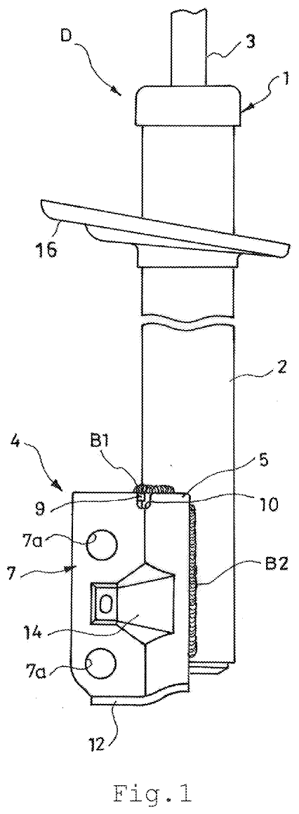

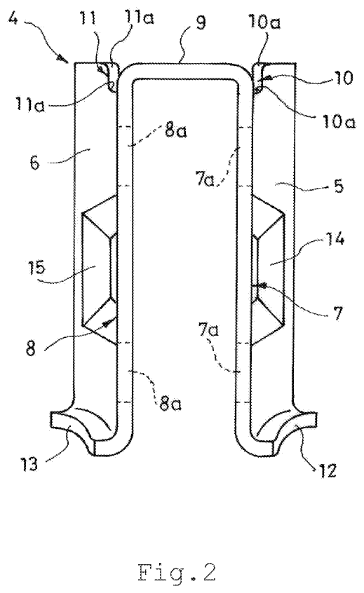

Hereinafter, the present invention will be described based on an embodiment illustrated in the drawings. As illustrated in FIGS. 1 and 2, a shock absorber D includes a shock absorber main body 1 having an outer shell 2 and a rod 3 that is movably inserted into the outer shell 2, and a knuckle bracket 4 that is attached, by welding, to an outer periphery of the bottom end of the outer shell 2, and is interposed between a vehicle body and a wheel of the vehicle by connecting the shock absorber D to a knuckle that supports the wheel, not illustrated, in the vehicle using the knuckle bracket 4.

Various parts of the shock absorber D will be described in detail below. The shock absorber main body 1 includes the cylindrical outer shell 2 and the rod 3 that is movably inserted into the outer shell 2, and dampens the vibration of the vehicle body and the wheel of the vehicle, by generating a damping force for inhibiting a relative movement of the rod 3 with respect to the outer shell 2, through an extending and contracting movement, in which the rod 3 moves relatively with respect to the outer shell 2 in the axial directions.

The shock absorber main body 1 includes, for example, the cylindrical outer shell 2 the bottom end of which is closed, a cylinder (not illustrated) that is housed inside the outer shell 2, the rod 3 that is movably inserted into the cylinder, a piston connected to the rod 3 and inserted into the cylinder to partition the internal space of the cylinder into an extension side chamber and a compression side chamber, a reservoir that is formed between the cylinder and the outer shell 2, and a valve case that is provided to the bottom end of the cylinder to provide a partition between the compression side chamber and the reservoir. The extension side chamber and the compression side chamber are filled with a liquid such as hydraulic oil, and the reservoir is filled with liquid and gas. Note that a liquid other than hydraulic oil such as water and an aqueous solution may also be used as the liquid used in the shock absorber D. Note that the outer shell 2 is a member forming the outermost shell of the shock absorber main body 1 to which the knuckle bracket 4 is attached, and may be a member that covers the rod instead of accommodating a cylinder or the like in a case where the shock absorber main body 1 is set as an inverted type.

In addition, the shock absorber main body 1 includes a passage that allows communication between an extension side chamber and a compression side chamber and a passage that communicates the compression side chamber with a reservoir, and each passage is provided with a damping valve. In the shock absorber main body 1 having the configuration described above, during its extending and contracting movement, the extension side chamber and the compression side chamber are expanded and compressed by the piston, and the liquid moves through the passages. The damping valve generates a damping force by resisting the liquid flow.

Note that a lower suspension spring seat 16 supporting the bottom end of a suspension spring, not illustrated, is mounted on of the middle of the outer periphery of the outer shell 2. This suspension spring not illustrated is interposed between the upper suspension spring bearing mounted on the tip end of the rod 3 and the lower suspension spring seat 16 described above, and, when the shock absorber D is interposed between the vehicle body and the wheel, the shock absorber D supports the vehicle body elastically.

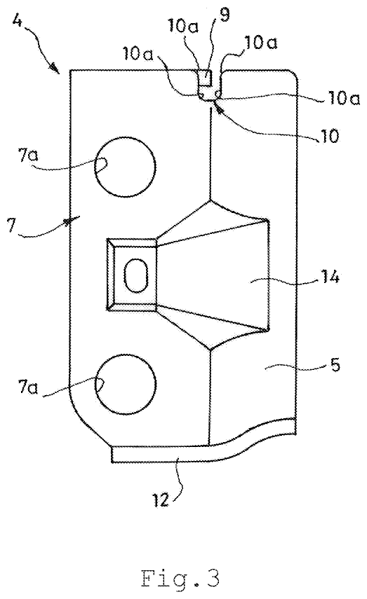

As illustrated in FIGS. 1 to 5, the knuckle bracket 4 is formed by forming a single metal plate as a base material, punching the base material into a developed shape of the knuckle bracket 4, and then bending the base material. The knuckle bracket 4 includes a pair of clamping pieces 5 and 6 that are curved along the outer periphery of the outer shell 2 and clamp the outer shell 2, a pair of attachment pieces 7 and 8 that extend in the radial direction of the outer shell 2 from the ends in the circumferential direction of the clamping pieces 5 and 6 and face each other, a connecting piece 9 that connects the upper ends of the attachment pieces 7 and 8, and a pair of notches 10 and 11 that cut off a three-plane intersection point where the clamping pieces 5 and 6, the attachment pieces 7 and 8, and the connecting piece 9 intersect.

Each of the clamping pieces 5 and 6 is a plate curved along the outer peripheral shape of the lower end of the outer shell 2 as viewed from the axial direction of the outer shell 2, and abuts on the inner peripheral surface along the axial direction of the outer shell 2 as viewed from the side of the outer shell 2.

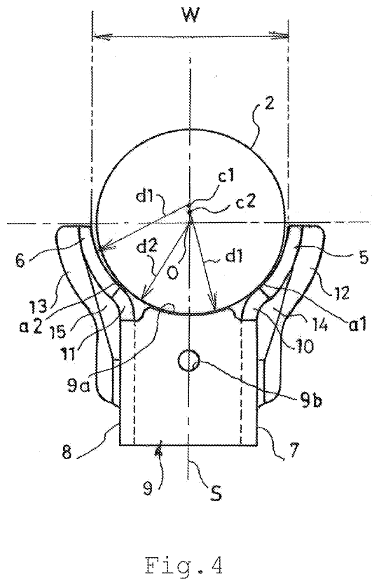

As illustrated in FIG. 4, when the clamping pieces 5 and 6 abut on the outer periphery of the outer shell 2, the proximal end side than the tip end in the circumferential direction of the inner peripheral surface of the clamping piece 5 and the proximal end side than the tip end in the circumferential direction of the inner peripheral surface of the clamping piece 6 abuts on the outer periphery of the outer shell 2, and a gap is generated between the tip ends of the inner peripheral surfaces of the clamping pieces 5 and 6 and the outer periphery of the outer shell 2. Therefore, since the outer periphery of the outer shell 2 abuts on a certain place on the proximal end side than the tip end except for the tip end of the inner peripheral surface of each of the clamping pieces 5 and 6, the outer shell 2 is supported at two places by the clamping pieces 5 and 6.

In the shock absorber D of the present embodiment, the curvature radius of the inner peripheral surfaces of the clamping pieces 5 and 6 is larger than the radius of the outer periphery of the outer shell 2, and a curvature center c1 of the inner peripheral surfaces of the clamping pieces 5 and 6 is disposed on a straight line S passing through the center of the connecting piece 9 in the circumferential direction and a center O of the outer diameter of the outer shell 2 when the outer shell 2 is viewed from the axial direction and on one side opposite to the center O.

In addition, the tip ends of the clamping pieces 5 and 6, which are opposite attachment piece side ends in the circumferential direction, do not go beyond a half of the outer shell 2 as viewed from the axial direction of the outer shell 2. As described above, since the tip ends of the clamping pieces 5 and 6, which are opposite attachment piece side ends, do not exceed a half of the outer shell 2 as viewed from the axial direction of the outer shell 2, when the knuckle bracket 4 is made to abut on the outer periphery of the lower end of the outer shell 2 in order to weld the knuckle bracket 4 to the outer periphery of the outer shell 2, the knuckle bracket 4 may be brought close to the outer shell 2 from the side, so that the assembly work is facilitated. Note that, as illustrated in FIG. 4, a width W between the tip ends of the clamping pieces 5 and 6, which are the opposite attachment piece side ends in the circumferential direction on the inner peripheral surfaces is longer than the outer diameter of the outer shell 2. However, the width W may be shorter than the outer diameter of the outer shell 2 as long as the proximal end side than the tip end in the circumferential direction of the inner peripheral surface of the clamping piece 5 and the proximal end side than the tip end in the circumferential direction of the inner peripheral surface of the clamping piece 6 abut on the outer periphery of the outer shell 2.

In addition, the attachment pieces 7 and 8 extend in parallel to each other in the radial direction of the outer shell 2 from the proximal ends in the circumferential direction of the clamping pieces 5 and 6 and face each other, and two bolt insertion holes 7a and 8a are provided at positions capable of facing two holes provided in the attachment portion of the knuckle (not illustrated). Then, the attachment portion of the knuckle (not illustrated) is inserted between the attachment pieces 7 and 8, and the attachment pieces 7 and 8 and the attachment portion are bolted by a bolt and a nut (not illustrated) penetrating the attachment portion of the knuckle inserted into the bolt insertion holes 7a and 8a, so that the knuckle bracket 4 can be attached to the knuckle.

The lower ends of the attachment piece 7 and the clamping piece 5 and the lower ends of the attachment piece 8 and the clamping piece 6 are bent outward to be away from the outer shell 2, and are provided with flange-shaped reinforcing ribs 12 and 13. Furthermore, a bulge portion 14 that is chipped from the center of the attachment piece 7 in the vertical direction to the center of the clamping piece 5 in the vertical direction and bulges away from the outer shell 2 is provided, and a bulge portion 15 that is chipped from the center of the attachment piece 8 in the vertical direction to the center of the clamping piece 6 in the vertical direction and bulges away from the outer shell 2 is provided. The reinforcing ribs 12 and 13 and the bulge portions 14 and 15 are provided to improve strength against a load that deforms the knuckle bracket 4.

The upper ends of the attachment pieces 7 and 8 are connected to each other by the connecting piece 9 perpendicular to the attachment pieces 7 and 8. A side surface 9a of the connecting piece 9 facing the clamping pieces 5 and 6 and facing the outer peripheral surface of the outer shell 2 is curved along the outer periphery of the outer shell 2, and when the clamping pieces 5 and 6 abut on the outer periphery of the outer shell 2, the side surface 9a of the connecting piece 9 also abuts on the outer periphery of the outer shell 2. As described above, in the knuckle bracket 4, the attachment pieces 7 and 8 and the connecting piece 9 have a box shape, and the proximal ends of the attachment pieces 7 and 8 are connected to the clamping pieces 5 and 6, respectively. A reference hole 9b is provided at the center of the connecting piece 9 in the left-right direction in FIG. 4.

The side surface 9a of the connecting piece 9 facing the outer shell is curved and abuts on an outer periphery of the outer shell 2. Specifically, the curvature radius of the side surface 9a of the connecting piece 9 is equal to the curvature radius of the inner peripheral surfaces of the clamping pieces 5 and 6, and is larger than the radius of the outer diameter of the outer shell 2. In addition, a curvature center c2 of the side surface 9a of the connecting piece 9 is arranged on the straight line S passing through the center of the connecting piece 9 and the center O of the outer diameter of the outer shell 2 when the outer shell 2 is viewed from the axial direction, on the connecting piece side to the center O, and on one side opposite to the center O, with respect to the curvature center c1 of the inner peripheral surfaces of the clamping pieces 5 and 6.

That is, the curvature radii of the side surface 9a of the connecting piece 9 and the inner peripheral surfaces of the clamping pieces 5 and 6 are equal and larger than the radius of the outer shell 2, the curvature center c2 of the side surface 9a of the connecting piece 9 is arranged on one side opposite to the connecting piece side from the center O of the radius of the outer shell 2 on the straight line S passing through the center of the connecting piece 9 in the circumferential direction, and the curvature center c1 of each of the clamping pieces 5 and 6 is arranged on one side opposite to the connecting piece side from the curvature center c2 of the side surface 9a of the connecting piece 9 on the straight line S. More specifically, a curvature radius d1 of the side surface 9a of the connecting piece 9 and the inner peripheral surface of each of the clamping pieces 5 and 6 is larger than the radius d2 of the outer shell 2, the curvature center c2 of the side surface 9a of the connecting piece 9 is arranged on one side opposite to the connecting piece side with respect to the center O of the radius of the outer shell 2, and the curvature center c1 of each of the clamping pieces 5 and 6 is arranged on the straight line S and on one side opposite to the connecting piece side with respect to the curvature center c2 of the side surface 9a of the connecting piece 9.

In addition, the knuckle bracket 4 includes the notches 10 and 11 at an upper end of a boundary between the clamping piece 5 and the attachment piece 7 and an upper end of a boundary between the clamping piece 6 and the attachment piece 8, respectively. The notch 10 is provided to cut off a three-plane intersection point which is an intersection point of three surfaces of the clamping piece 5, the attachment piece 7, and the connecting piece 9, and the notch 11 is provided to cut off a three-plane intersection point which is an intersection point of three surfaces of the clamping piece 6, the attachment piece 8, and the connecting piece 9.

Each of the notches 10 and 11 is opened from an upper end of a boundary between the clamping pieces 5 and 6, the attachment pieces 7 and 8, and the connecting piece 9 and is formed by cutting a base material downward into a rectangular shape, and includes chamfered portions 10a and 11a formed by chamfering four corner portions in an R shape.

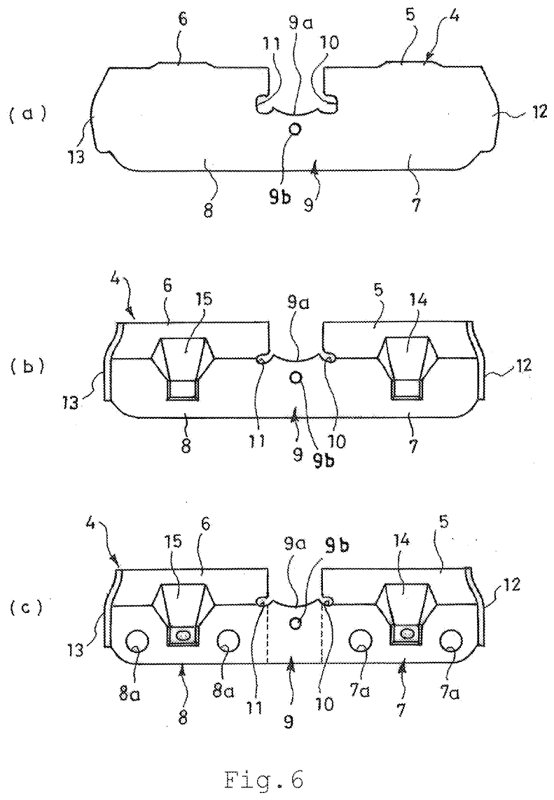

The knuckle bracket 4 configured as described above is manufactured by the following procedure. First, a base material of a rectangular metal flat plate-like blank (not illustrated) is punched to obtain a flat plate having a shape in which the knuckle bracket 4 illustrated in FIG. 6(a) is developed. The reference hole 9b in the connecting piece 9 is also formed by punching a blank base material to obtain the flat plate. The reference hole 9b serves as a reference indicating the position of the center of the flat plate, and is used for positioning with respect to the processing device in processing of bending the flat plate following the punching of the base material.

Subsequently, the flat plate is bent and molded by press working to mold the clamping pieces 5 and 6, the attachment pieces 7 and 8, the reinforcing ribs 12 and 13, and the bulge portions 14 and 15 as illustrated in FIG. 6(b), and then the bolt insertion holes 7a and 8a are punched into the attachment pieces 7 and 8 as illustrated in FIG. 6(c). When bending processing of bending the semi-finished product of the knuckle bracket 4, which has been drilled in FIG. 6(c), is performed with a broken line in FIG. 6(c), the connecting piece 9 and the attachment pieces 7 and 8 are bent at a right angle, and the knuckle bracket 4 can be manufactured.

Although the knuckle bracket 4 is manufactured in this manner, the two three-plane intersection points of the clamping pieces 5 and 6, the attachment pieces 7 and 8, and the connecting piece 9 are cut off by the notches 10 and 11, respectively, and the clamping pieces 5 and 6 are not continuous with the boundaries of the connecting piece 9 and the attachment pieces 7 and 8, so that the clamping pieces 5 and 6 do not interfere with the bending molding when the molding to be bent at the boundaries of the connecting piece 9 and the attachment pieces 7 and 8 is performed. Therefore, even the knuckle bracket 4 having a shape in which a three-plane intersection point with the clamping pieces 5 and 6, the attachment pieces 7 and 8, and the connecting piece 9 is formed can be molded without difficulty.

When the knuckle bracket 4 thus obtained is brought close to and abuts on the outer periphery of the outer shell 2 from the side, the knuckle bracket 4 abuts on the outer peripheral surface of the outer shell 2 at two portions on the proximal end side than the tip end of the curved inner peripheral surfaces of the clamping pieces 5 and 6, and the side surface 9a of the connecting piece 9 abuts on the outer peripheral surface of the outer shell 2, so that the outer shell 2 is supported by the knuckle bracket 4 at three points in the circumferential direction.

Since the width W between the tip ends of the clamping pieces 5 and 6, which are the opposite attachment piece side ends on the inner peripheral surfaces, is larger than the outer diameter of the outer shell 2, when the outer shell 2 is inserted between the clamping pieces 5 and 6 from the side, the outer shell 2 enters between the clamping pieces 5 and 6 without being caught by the tip ends of the clamping pieces 5 and 6 in the circumferential direction, and abuts on two portions on the proximal end side excluding the tip end in the circumferential direction of the inner peripheral surfaces of the clamping pieces 5 and 6 to be supported in the circumferential direction by the clamping pieces 5 and 6. Therefore, even in a situation where there is a slight error in the dimensions of the outer shell 2 and the clamping pieces 5 and 6 and the outer shell 2 cannot abut on the connecting piece 9, the outer shell 2 is always stably supported at two points by the inner peripheral surfaces of the clamping pieces 5 and 6, and a large gap is not formed between the outer shell 2 and the inner peripheral surfaces of the clamping pieces 5 and 6 and between the outer shell 2 and the side surface 9a of the connecting piece 9. Therefore, the outer shell 2 abuts on the tip ends of the inner peripheral surfaces of the clamping pieces 5 and 6 and rises from the clamping pieces 5 and 6, so that an excessively large gap does not occur between the inner peripheral surfaces of the clamping pieces 5 and 6 and the side surface 9a of the connecting piece 9 and the outer shell 2, and the outer shell 2 does not idle and rattle between the clamping pieces 5 and 6. When the knuckle bracket 4 is welded to the outer shell 2 in a state where the outer shell 2 is rattled between the clamping pieces 5 and 6, the knuckle bracket 4 may not be attached to the outer shell 2 at an appropriate position, and it may be difficult to connect the shock absorber D to the knuckle. However, the shock absorber D of the present embodiment can avoid such a situation.

As described above, after the outer shell 2 is stably supported in the circumferential direction with respect to the knuckle bracket 4 without generating a large gap between the outer shell 2 and the inner peripheral surfaces of the clamping pieces 5 and 6 and the side surface 9a of the connecting piece 9, the knuckle bracket 4 is fixed to the outer shell 2 by welding.

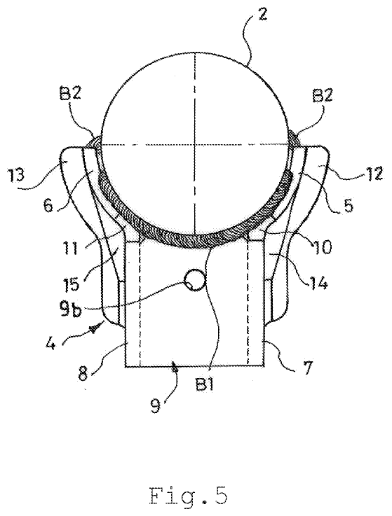

Specifically, as illustrated in FIGS. 1 and 5, the outer shell 2 is arc-welded from the tip end side of the upper end of the clamping piece 5 to the tip end side of the upper end of the clamping piece 6 on the opposite side via the upper side of the side surface of the connecting piece 9, and the tip end of each of the clamping pieces 5 and 6 is arc-welded along the axial direction to the outer periphery of the outer shell 2, and the knuckle bracket 4 is fixed to the outer shell 2 by welding.

As described above, in the shock absorber D of the present embodiment, a welded portion B1 is formed from a vicinity of the opposite attachment piece side end of the upper end of the clamping piece 5 via the upper side of the connecting piece 9 to a vicinity of the upper end of the opposite attachment piece side end of the clamping piece 6 opposite to the attachment piece side, and a linear welded portion B2 is formed along the axial direction of the outer shell 2 from a vicinity near the upper end to near the lower end of the opposite attachment piece side end of each clamping pieces 5 and 6. Although the welded portions B1 and B2 are formed by melting the material to be welded and the welding material of the knuckle bracket 4 and the outer shell 2, the outer shell 2 is stably supported by the knuckle bracket 4, and an excessively large gap does not occur between the outer shell 2 and the inner peripheral surfaces of the clamping pieces 5 and 6 and the side surface 9a of the connecting piece 9. Therefore, since the melted bead stays in the welded portions B1 and B2 and does not flow down, the good welded portions B1 and B2 can be formed. Therefore, the welding quality between the outer shell 2 and the knuckle bracket 4 is improved, the welding quality is stabilized, and the knuckle bracket 4 is firmly fixed to the outer shell 2.

In addition, the knuckle bracket 4 includes the connecting piece 9 that connects the upper ends of the attachment pieces 7 and 8, and since the attachment pieces 7 and 8 and the connecting piece 9 form a box shape, high strength can be realized, and the knuckle bracket 4 can sufficiently withstand various loads such as bending, shearing, and pulling input from the knuckle that supports the wheel of the vehicle.

As described above, in order to obtain the high-strength knuckle bracket 4, the connecting piece 9 connecting the upper ends from the bases of the clamping pieces 5 and 6 at the upper ends of the attachment pieces 7 and 8 is indispensable. However, in a case where the notches 10 and 11 are not provided, the three-plane intersection point, which is the intersection point of the three surfaces of the clamping pieces 5 and 6, the attachment pieces 7 and 8, and the connecting piece 9, remains in the base material, and it is difficult to bend the attachment pieces 7 and 8 at a right angle with respect to the connecting piece 9, and it is very difficult to mold the knuckle bracket 4. However, in the shock absorber D of the present embodiment, since the knuckle bracket 4 includes the notches 10 and 11 that cut off the three-plane intersection points where the clamping pieces 5 and 6, the attachment pieces 7 and 8, and the connecting piece 9 intersect, the knuckle bracket 4 in which the clamping pieces 5 and 6 do not interfere with the bending molding when the bending molding is performed at the boundary between the connecting piece 9 and the attachment pieces 7 and 8 can be molded without difficulty.

As described above, the shock absorber D of the present embodiment includes the shock absorber main body 1 having the cylindrical outer shell 2 and the rod 3 movably inserted into the outer shell 2, and the knuckle bracket 4 attached to an outer periphery of a lower end of the outer shell 2, in which the knuckle bracket 4 includes the pair of clamping pieces 5 and 6 that are curved along an outer periphery of the outer shell 2 and clamp the outer shell 2, the pair of attachment pieces 7 and 8 that extend in a radial direction of the outer shell 2 from the ends in a circumferential direction of the respective clamping pieces 5 and 6 and face each other, and the connecting piece 9 that connects ends of the attachment pieces 7 and 8, and a proximal end side than a tip end in a circumferential direction of an inner peripheral surface of each of the clamping pieces 5 and 6 abuts on the outer periphery of the outer shell 2.

In the shock absorber D configured as described above, when the outer shell 2 is inserted between the clamping pieces 5 and 6 from the side, the outer shell 2 enters between the clamping pieces 5 and 6 without abutting on the distal end of the clamping piece 5 and 6 in the circumferential direction, and is stably supported by being in contact with two portions on the proximal end side excluding the tip end in the circumferential direction of the inner peripheral surface of the clamping piece 5 and 6, and an excessively large gap is not generated between the inner peripheral surface of the clamping piece 5 and 6 and the side surface 9a of the connecting piece 9 and the outer shell 2. As described above, according to the shock absorber D of the present embodiment, the outer shell 2 is stably supported by the knuckle bracket 4, and an excessively large gap does not occur between the outer shell 2 and the inner peripheral surfaces of the clamping pieces 5 and 6 and the side surface 9a of the connecting piece 9. Therefore, when the upper ends of the clamping pieces 5 and 6, the tip ends of the clamping pieces 5 and 6 in the circumferential direction, and the side surface 9a of the connecting piece 9 are welded to the outer shell 2, the welded portions B1 and B2 having good and stable welding quality are obtained. As described above, according to the shock absorber D of the present embodiment, it is possible to achieve both improvement and stability in welding quality at the welded portions B1 and B2 between the outer shell 2 and the knuckle bracket 4.

In addition, in the shock absorber D of the present embodiment, the distance from the inner peripheral surface of each of the clamping pieces 5 and 6 to the outer shell 2 increases from the contact points a1 and a2 between the inner peripheral surface of each of the clamping pieces 5 and 6 and the outer shell 2 toward the tip end side of each of the clamping pieces 5 and 6. When the shock absorber D is configured in this manner, since the width on the tip end side of the inner peripheral surface of each of the clamping pieces 5 and 6 of the outer shell 2 is widened, the outer shell 2 is smoothly inserted between the clamping pieces 5 and 6, and the outer shell 2 can stably abut on the proximal end side of the inner peripheral surface of each of the clamping pieces 5 and 6.

Note that the inner peripheral surfaces of the clamping pieces 5 and 6 may be curved surfaces whose curvature radius changes. However, when the curvature radius of the inner peripheral surfaces of the clamping pieces 5 and 6 is constant and larger than the radius of the outer periphery of the outer shell 2, the knuckle bracket 4 can be easily manufactured and dimensional management can be easily performed.

In addition, in the shock absorber D of the present embodiment, when the outer shell 2 abuts on the side surface 9a of the connecting piece 9 as well as the outer shell 2 abuts on the two portions on the proximal end side excluding the tip end in the circumferential direction of the inner peripheral surfaces of the clamping pieces 5 and 6, the outer shell 2 is supported at three points by the knuckle bracket 4, so that it is possible to further improve and stabilize the welding quality at the welded portions B1 and B2 between the outer shell 2 and the knuckle bracket 4, and it is possible to improve the welding strength between the connecting piece 9 and the outer shell 2.

Furthermore, in the shock absorber D of the present embodiment, the side surface 9a of the connecting piece 9 facing the outer shell 2 is curved, and the central portion abuts on the outer periphery of the outer shell 2. According to the shock absorber D configured as described above, when the connecting piece 9 is welded to the outer shell 2, the welding quality of the central portion of the connecting piece 9 is improved, so that the welding strength can be further improved.

The inner peripheral surfaces of the clamping pieces 5 and 6 may be curved surfaces whose curvature changes as long as the width W between the tip ends in the circumferential direction on the inner peripheral surfaces of the clamping pieces 5 and 6 is larger than the outer diameter of the outer shell 2. In a case where the inner peripheral surfaces of the clamping pieces 5 and 6 are formed to pass through a circle having a radius d1 centered on the curvature center c1, it is easy to manage the dimensions of the knuckle bracket 4.

In addition, in the shock absorber D of the present embodiment, even if the clamping pieces 5 and 6 of the knuckle bracket 4 do not surround the outer periphery of the outer shell 2, the knuckle bracket 4 can be firmly fixed to the outer shell 2, and since the attachment pieces 7 and 8 and the connecting piece 9 form a box shape, the strength of the knuckle bracket 4 can be increased to withstand the load input from the knuckle. Since the knuckle bracket 4 includes the pair of notches 10 and 11 for cutting off the three-plane intersection point where the clamping pieces 5 and 6, the attachment pieces 7 and 8, and the connecting piece 9 intersect, the knuckle bracket 4 having high strength can be firmly fixed to the outer shell 2 and can be molded without difficulty.

Since the knuckle bracket 4 does not include a holding portion surrounding the outer shell 2 unlike the conventional knuckle bracket, the knuckle bracket 4 is smaller in size than the conventional knuckle bracket. Therefore, the material required for manufacturing is reduced, and the weight is also reduced.

As described above, according to the shock absorber D of the present embodiment, it is possible to use the small and lightweight knuckle bracket 4, so that the material yield regarding the manufacturing of the knuckle bracket 4 is improved, and thus, it is possible to reduce the cost related to the manufacturing of the shock absorber D and the overall weight of the shock absorber D.

In addition, in the shock absorber D of the present embodiment, since the notches 10 and 11 are rectangular and the corner portions are chamfered in a round surface shape, it is possible to alleviate stress concentration when a load is input from the knuckle to the knuckle bracket 4 by providing the notches 10 and 11.

Note that the width dimension and the length dimension of the notches 10 and 11 can be arbitrarily designed as long as the three-plane intersection point can be cut off, but may be designed in consideration of a die life and maintainability of punching a flat plate having a shape obtained by developing the knuckle bracket 4 illustrated in FIG. 6(a) without causing a significant decrease in the strength of the knuckle bracket 4.

The shapes and dimensions of the attachment pieces 7 and 8 and the connecting piece 9 of the knuckle bracket 4 can be appropriately designed and changed according to the outer diameter of the outer shell 2, the shape of the knuckle of the vehicle, and the like as long as the above-described effects are not lost. In addition, the tip ends of the clamping pieces 5 and 6 in the circumferential direction can protrude even if the tip ends extend to one side opposite to the attachment piece side beyond a half of the outer shell 2 as long as welding to the outer shell 2 is not hindered. However, since the outer shell 2 cannot be inserted into the clamping pieces 5 and 6 from the side while the weight of the clamping pieces 5 and 6 increases, it is preferable that the tip ends of the clamping pieces 5 and 6, which are opposite attachment piece side ends in the circumferential direction do not exceed a half of the outer shell 2 as viewed from the axial direction of the outer shell 2. In addition, there is also an advantage that the material yield of the knuckle bracket 4 can be increased by preventing the tip end of the clamping pieces 5 and 6, which is an opposite attachment piece side end in the circumferential direction, from exceeding half of the outer shell 2 as viewed from the axial direction of the outer shell 2. The length in the axial direction of the outer shell 2 at the tip ends in the circumferential direction of the clamping pieces 5 and 6 can be appropriately designed and changed according to the bonding strength required in the specification.

In addition, the inner peripheral surfaces of the clamping pieces 5 and 6 may be curved surfaces whose curvatures change. Furthermore, as long as the outer shell 2 can abut on the proximal end side of the inner peripheral surface of each of the clamping pieces 5 and 6, the shape of the inner peripheral surface of each of the clamping pieces 5 and 6 can be modified in any manner.

Although the preferred embodiment of the present invention has been described above in detail, modifications, variations, and changes can be made thereto without departing from the claims.

### REFERENCE SIGNS LIST

1 Shock absorber main body
2 Outer shell
3 Rod
4 Knuckle bracket
5, 6 Clamping piece
7, 8 Attachment piece
9 Connecting piece
9a Side surface
a1, a2 Contact point
c1 Curvature center of inner peripheral surface of
clamping piece
c2 Curvature center of side surface of connecting piece
D Shock absorber
d1 Curvature radius of inner peripheral surface of
clamping piece and side surface of connecting piece
d2 Radius of outer shell
O Center of radius of outer shell
S Straight line

1. A shock absorber comprising:
a shock absorber main body having a cylindrical outer shell and a rod movably inserted into the cylindrical outer shell; and
a knuckle bracket attached to an outer periphery of a lower end of the cylindrical outer shell, wherein
the knuckle bracket includes a pair of clamping pieces that are curved along an outer periphery of the cylindrical outer shell and clamp the cylindrical outer shell,
a pair of attachment pieces that extend in a radial direction of the cylindrical outer shell from ends in a circumferential direction of the respective clamping pieces and face each other, and
a connecting piece that connects ends of the attachment pieces, and
a proximal end side than a tip end in a circumferential direction of an inner peripheral surface of each of the clamping pieces abuts on the outer periphery of the cylindrical outer shell.

2. The shock absorber according to claim 1, wherein
a distance from the inner peripheral surface of each of the clamping pieces to the cylindrical outer shell increases from a contact point between the inner peripheral surface of each of the clamping pieces and the cylindrical outer shell toward a tip end side of each of the clamping pieces.

3. The shock absorber according to claim 1, wherein
a curvature radius of the inner peripheral surface of each of the clamping pieces is made larger than a radius of the outer periphery of the cylindrical outer shell.

4. The shock absorber according to claim 1, wherein
a side surface of the connecting piece facing the cylindrical outer shell abuts on the outer periphery of the cylindrical outer shell.

5. The shock absorber according to claim 1, wherein
a side surface of the connecting piece facing the cylindrical outer shell is curved, and a central portion thereof abuts on the outer periphery of the cylindrical outer shell.

6. The shock absorber according to claim 2, wherein
a curvature radius of the inner peripheral surface of each of the clamping pieces is made larger than a radius of the outer periphery of the cylindrical outer shell.
